(19) United States
(12) Patent Application Publication
(10) Pub. No.: US 2004/0203835 A1
(43) Pub. Date: Oct. 14, 2004

(54) Integrated telephony and television system

(76) Inventors: Kevin Trottier, Dallas, TX (US); Hooman Famili, Irving, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/131,788

(22) Filed: Apr. 24, 2002

(51) Int. Cl. H04Q 7/20

(52) U.S. Cl. 455/454; 455/414.1; 455/426.1

(57) ABSTRACT

A system and method for presenting an incoming telephony call on a display of a television set is disclosed. The method comprises receiving the incoming telephony call, selecting at least one of a plurality of images based at least in part on a caller identification number associated with the incoming telephony call, generating a computer video image to be presented on the display, the computer video image comprising the selected at least one image, and providing the computer video image to the television set.

### TECHNICAL FIELD OF THE INVENTION

The present invention relates generally to the field of telephony, and more particularly to an integrated telephony and television system.

### BACKGROUND OF THE INVENTION

Due to the increase in use of traditional television sets in homes all over the world, various peripheral devices and services have emerged that provide additional utility in conjunction with the television set. Some of the services provided in conjunction with the traditional television set include cable services and satellite services. Some of the peripheral devices that operate in conjunction with a traditional television set are video cassette recorders, DVD players, video game consoles etc. Some existing peripheral devices in the form of set-top boxes connected to the television set also provide the ability to access the Internet via the traditional television set.

Due to the availability of various services and peripheral devices that operate in conjunction with the television set, consumers/users are spending more time in front of their television sets than ever before. Featured in the center of any living room or family room is the ubiquitous television set in its various incarnations. When a consumer receives a phone call while he or she is watching their favorite program on the television, the consumer is very reluctant to answer the phone. Sometimes the telephone set is located such that the consumer has to get off the couch to answer the phone. Other times, the consumer simply has a hard time locating the cordless telephone handset. Often, they let the answering machine or voicemail system pick up the phone call to record a message from the caller. The result may be an endless string of phone tags played out between the caller and the called party.

### SUMMARY OF THE INVENTION

In order to simplify the life of the consumer, it is desirable to provide the consumer with an integrated telephony and television system so that an incoming telephony call may be presented on a display of a television set.

In accordance with an embodiment of the present invention, a method for presenting an incoming telephony call on a display of a television set is disclosed. The method comprises receiving the incoming telephony call, selecting at least one of a plurality of images based at least in part on a caller identification number associated with the incoming telephony call, generating a computer video image to be presented on the display, the computer video image comprising the selected at least one image, and providing the computer video image to the television set.

In accordance with another embodiment of the present invention, a system for presenting an incoming telephony call on a display of a television set is disclosed. The system comprises a controller operable to generate a computer video image to be presented on the display, the computer video image comprising at least one of a plurality of images selected based at least in part on a caller identification information associated with the incoming telephony call. The system also comprises a video mixer operable to receive the computer video image from the controller, the video mixer further operable to generate a combined image from the computer video image and an image generated from video signals received from a video source, and provide the combined image to the television set.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a high level diagram of an integrated telephony and television system in accordance with an embodiment of the present invention;

FIG. 2 is a block diagram of an integration device in accordance with an embodiment of the present invention;

FIG. 3 is a flowchart of a preferred embodiment method for configuring telephony features on a web services server;

FIG. 4 is a flowchart of a preferred embodiment method for displaying an incoming telephony call on a television set; and

FIG. 5 is a flowchart of a preferred embodiment method of operation of an integration device in response to receiving a signal from a control device.

### DETAILED DESCRIPTION OF THE DRAWINGS

The preferred embodiment of the present invention and its advantages are best understood by referring to FIGS. 1 through 5 of the drawings.

A disadvantage of existing integrated telephony and television systems is that the telephony features are configured, if at all, via a set-top box acting in conjunction with a television set. These systems provide limited flexibility to a user for configuring different parameters for controlling the telephony features. Accordingly, there is a desire for an integrated telephony and television system that provides enhanced features to the user. The preferred embodiment system is an Internet-aware system that uses a television set to interact with the user. The user is able to configure features, such as telephony features, by accessing a web site using a personal computer or any other device. If desired, the configuration of the features may be performed in conjunction with an online calendar and address book. The configured features may be stored in a web services server and managed via the Internet. The configured features may then be downloaded to a preferred embodiment integration device. The integration device integrates signals from different sources to present a graphical output comprising of television programming and telephony features on the television set. Thus, for example, the user may be alerted via the television set when a telephone call comes through or a voicemail message is waiting for the user. The alert is presented unobtrusively on the television set so that the user may continue viewing the television programming. The integrated system utilizes a telecommunications network, such as a Public Switched Telephone Network (PSTN), a Voice over Internet Protocol (VoIP) network, and/or the like, for telephony communications, the Internet for providing web services and the television set for interacting with the user.

FIG. 1 is a high level diagram of an integrated telephony and television system 10 in accordance with an embodiment of the present invention. System 10 comprises an integration device 12 coupled to a television set 14. Integration device 12 facilitates the integration of telephony, television and the Internet in accordance with an embodiment of the present invention. Integration device 12 may also be coupled to an audio/video source 16. Audio/video source 16 is preferably used to provide programming to television set 14 via integration device 12. Audio/video source 16 provides audio and/or video signals to integration device 12. Audio/video source 16 may include a tuner for descrambling signals received from a cable system, a satellite system, and/or the like. Audio/video source 16 may comprise a cable set-top box, a satellite set-top box, and/or the like, for receiving television, cable or satellite programming. The terms “programming”, “television programming”, “cable programming” and “satellite programming” are used interchangeably herein. Audio/video source 16 may comprise a game console, a video cassette recorder, a DVD player, and/or the like. Although in the illustrated embodiment of FIG. 1, audio/video source 16 is shown as one device, the invention is not so limited. If desired, audio and video may be provided from different sources. Moreover, if desired, multiple sources of audio and/or video signals may be used. Furthermore, if desired, integration device 12 and audio/video source 16 may be part of the same device.

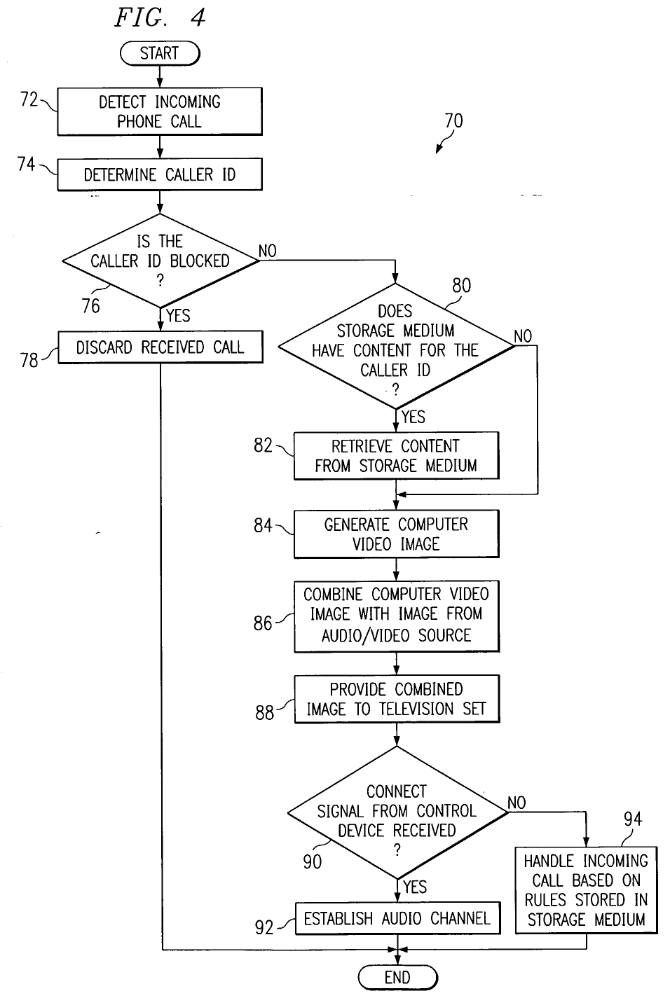

As described in greater detail herein with reference to FIG. 5, a user may interact with integration device 12 via a control device 18, such as a remote control, a game pad, and/or the like. The terms “control device”, “remote control” and “game pad” are used interchangeably herein. As described in greater detail herein with reference to FIG. 3, the user may also interact with integration device 12 indirectly via a processor based system 20, such as a personal computer, and/or the like, via communications network 22, such as the Internet, a VoIP network, a PSTN, and/or the like. In the indirect mode of interaction, the user may access a web services server 24 via communications network 22 to configure various telephony features. Web services server 24 may communicate with a local telephone company central office 26 via communications network 22 to download information regarding the telephony features currently subscribed by the user. Local telephone company central office 26 may communicate with a voicemail system 27 to access the user's voicemail messages. The communication between central office 26 and voicemail system 27 may take place using SMDI (Simplified Message Desk Interface) protocol, SS7 (Signaling System 7), SMS (Short Message Service), TCP/IP (Transmission Control Protocol/Internet Protocol), and/or the like. Integration device 12 may interact with web services server 24 via communications network 22 to download information and/or data, for example user subscribed telephony features, user configured telephony features, voice messages, image files, video files, address book, calendar, rules and/or the like.

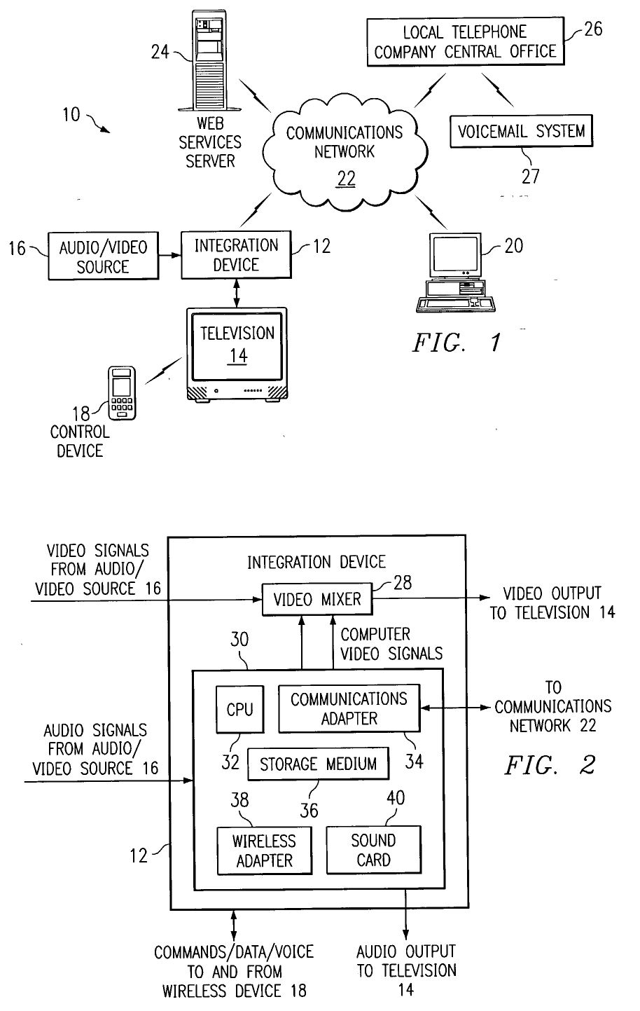

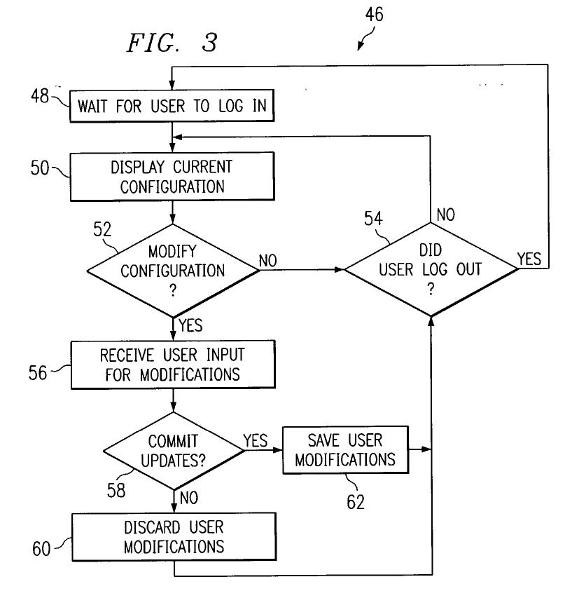

FIG. 2 is a block diagram of integration device 12 in accordance with an embodiment of the present invention. Integration device 12 comprises a video mixer 28 coupled to a controller 30. Controller 30 may comprise a central processing unit (CPU) 32, a communications adapter 34, a storage medium 36, a wireless adapter 38, and a sound card 40. Communications adapter 34 facilitates communication with web services server 24 via communications network 22 and may comprise a dial-up modem, a cable modem, a wireless modem, a wireless gateway, a xDSL modem, an ISDN converter, and/or the like. Storage medium 36 may be a conventional storage medium, such as a hard drive, used for storing information, such as image files, video files, program logic for generating an audio and/or video overlay for the telephony services, address book of the user, calendar of the user, rules, voice messages, and/or the like. Information in storage medium 36 may be updated periodically, for example by synchronizing storage medium 36 with information stored in web services server 24 via communications network 22.

Wireless adapter 38 facilitates communication with control device 18. Wireless adapter 38 may operate using one or more of the following technologies that uses omnidirectional radio waves that can transmit through walls and other non-metal barriers, such as 802.11, bluetooth, x.10, and/or the like. The communication between wireless adapter 38 and control device 18 may comprise of commands, data, and/or voice. Commands, data, and/or voice may be transmitted from wireless adapter 38 to control device 18 or from control device 18 to wireless adapter 38. Commands may be transmitted, for example from control device 18 to wireless adapter 38 in response to a user input. Data may comprise of information to be displayed on a display (not shown) which may be part of control device 18. Such data may include, for example the user's address book with telephone numbers, to enable the user to initiate a phone call using control device 18. A voice channel enables the user to engage in a telephone conversation using control device 18. If desired, the user may also listen to voice messages using control device 18.

Video mixer 28 is preferably a genlock or overlay mixer. It mixes video signals from multiple sources. The multiple sources may provide video signals in the same or different formats to video mixer 28. In a preferred embodiment, video mixer 28 combines video signals received from audio/video source 16 with computer video signals received from controller 30. The computer video signals may be VGA (Video Graphics Adapter) signals, SVGA (Super Video Graphics Adapter) signals, XVGA (eXtended Video Graphics Adapter) signals, and/or the like, now known or later developed. Controller 30 continuously generates computer video signals which result in a computer video image, which by default is a “blue screen”. Video mixer 28 replaces the blue portion of the “blue screen” with the corresponding portion of an image generated by the video signals received from audio/video source 16. Thus, when the computer video image does not include any non-blue portions, video mixer 28 passes the video signals received from audio/video source 16 to television set 14 without any modification. On the other hand, if the computer video signals generate a computer video image at least part of which is not blue, video mixer 28 overlays the non-blue portion of the computer video image on the image generated by the video signals received from audio/video source 16. The combined image is transmitted to television set 14. In the preferred embodiment, controller 30 generates a video image at least part of which is not blue, in response to i) receiving a signal for telephony services from control device 18, and/or ii) receiving a signal from communications network 22 related to telephony services. This is discussed in further detail hereinafter.

Audio signals from audio/video source 16 may be provided to sound card 40. Sound card 40 may simply transmit the audio signals to television set 14. If desired, controller 30 may process the audio signals prior to transmission to television set 14. In the preferred embodiment, the audio signals are processed prior to transmission, in response to i) controller 30 receiving a signal for telephony services from control device 18, and/or ii) receiving a signal from communications network 22 related to telephony services. Processing of the audio signal may comprise one or more of the following: lowering the volume, increasing the volume, overlaying the received audio signal with one or more call announcements, and/or the like.

FIG. 3 is a flowchart of a preferred embodiment method 46 for configuring telephony features on web services server 24. In step 48, web services server 24 waits for a user to log in via a web site. The user may log in to web services server 24 using processor based system 20. Once the user has logged into web services server 24, the current configuration for telephony services associated with integration device 12 may be displayed (step 50). The user's account on the web site may include for example, a calendar, an address book, information on the telephony services currently subscribed by the user, such as call blocking, caller ID, call forwarding anonymous call rejection, call announcements, speed dial, voicemail, and/or the like. In the preferred embodiment, when the user initially sets up the user account, information on the telephony services currently subscribed by the user may be downloaded by web services server 24 from local telephone company central office 26 via communications network 22. Thus, in order to set-up the account, the user does not have to manually provide information regarding the telephony services currently subscribed by the user. However, if desired, the user may manually provide the information.

The user may make selections on the web site using conventional methods to browse information. In step 52, a determination is made as to whether the user desires to modify the current configuration. If the user does not desire to modify the current configuration, then in step 54 a determination may be made as to whether the user logged out. If the user did not log out, then the process starting at step 50 may be executed to display the current configuration. If the user logged out, then the process starting at step 48 may be executed.

If in step 52, it is determined that the user desires to modify the current configuration, then in step 56 user input for modifications is received. The user may make changes to the address book, the calendar, the current user subscribed telephony services, and/or the like. In the preferred embodiment, the address book permits the user to associate content, such as image files, video files and/or the like with telephone numbers or names of individuals. The user may upload content to web services server 24 and associate them to the corresponding individuals in the address book. The image file may be in any format now known or later developed and may be the image of a person, the business logo of a company, and/or the like. The video file may be in any format now known or later developed. For example, the user may associate a picture of an individual with the telephone number of that individual, a business logo of a company with the telephone number of the company, and/or the like. If desired, the user may download content to be associated with the individuals in the address book from a remote database. The database may be a private or a public database, such as a DMV database, a national ID database, and/or the like. As discussed in more detail hereinafter, the images, if any, associated with the individuals may be displayed on television set 14 upon receipt of a phone call or voice message from the respective individuals.

The user may also set-up rules regarding telephony features, such as call forwarding, call blocking, anonymous call rejection, call announcements, speed dial, and/or the like at web services server 24. These rules may be set-up to work in conjunction with the calendar and/or address book so that a call received by integration device 12 may be forwarded to different phone numbers, an answering machine or voicemail system 27 depending on one or more of the following factors, such as time of the day, the caller, the user's schedule, and/or the like. If desired, rules may be set-up to work in conjunction with the calendar and/or address book to block and/or screen calls received by integration device 12. If desired, priority levels may be associated with one or more contacts in the address book so that calls received from contacts with a particular priority level are handled in a different manner than calls received from contacts with a different priority level. Rules may be set-up to handle calls received from contacts with the same priority in a similar manner. If desired, rules for handling calls may be set-up for the contacts individually irrespective of the priority level. Thus, for example, if the user is in a meeting and receives a call from his business partner, a rule may be set-up to either forward the call to the user's voicemail or to the user's cell phone, for example depending on who the user is meeting with. On the other hand, if the user is in a meeting and receives a phone call from someone with a different priority level, a rule may be set-up to always direct the call to voicemail system 27 irrespective of who the user is meeting with.

In step 58, a determination is made as to whether or not updates received from the user should be committed. A user may select a “Commit” option or a “Cancel” option to either commit or cancel the updates. If it is determined that the user desires to commit the updates, then in step 62 the user modifications are saved and the process starting at step 54 to determine if the user has logged out may be executed. If in step 58 it is determined that the user does not desire to commit the updates, then in step 60 the user modifications are discarded. The process starting at step 54 to determine if the user has logged out may then be executed.

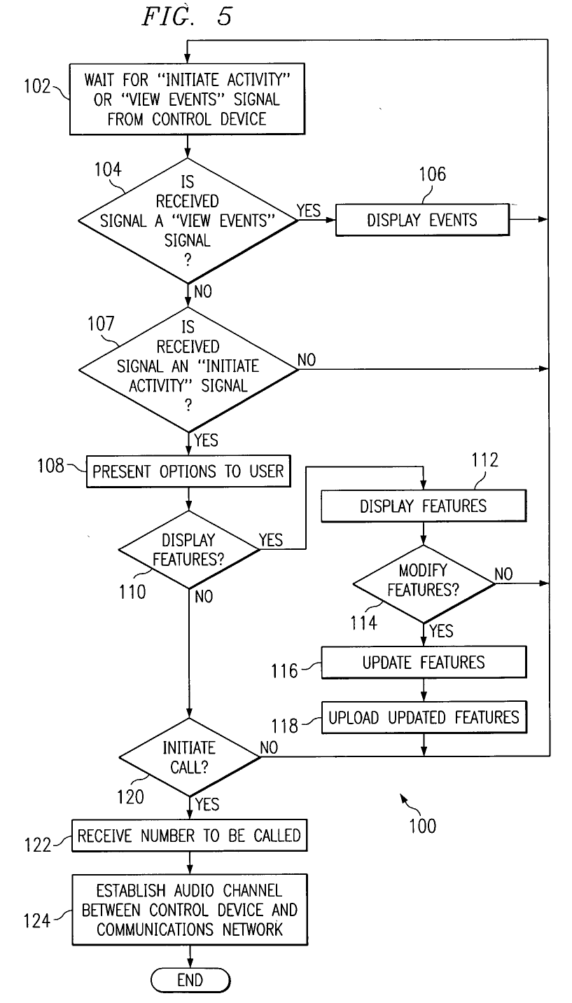

FIG. 4 is a flowchart of a preferred embodiment method 70 for displaying an incoming telephony call on a television set. In step 72, an incoming telephony call is detected, preferably by communications adapter 34. In the preferred embodiment, communications adapter 34 is continuously listening for an incoming telephony call from communications network 22, which may comprise a Public Switched Telephone Network. In step 74, a caller ID associated with the received call is determined. Any conventional method for determining caller ID, now known or later developed, may be used. In step 76, a determination is made as to whether the caller ID associated with the incoming call is blocked. If the caller ID associated with the incoming call is blocked, then in step 78, the received call may be discarded and the process terminated.

If in step 76 it is determined that the caller ID associated with the incoming call is not blocked, then in step 80 a determination is made as to whether content, for example an image, is stored in storage medium 36 for the caller ID. The address book downloaded from the web site and stored in storage medium 36 may be searched to determine if the caller ID of the received call has content associated with it in the address book. If the caller ID of the received call has content associated with it, then in step 82, the content is retrieved from storage medium 36. Irrespective of whether the received caller ID has content associated with it or not, in step 84, a computer video image is generated. The computer video image is preferably a “blue screen” which includes one or more of the following call information: a time stamp, the caller ID, caller name, call waiting ID, and/or the like. If the caller ID has content associated with it, then the “blue screen” also includes the content. Preferably, the generated blue screen includes the call information on a small portion of the blue screen so that the call information may be displayed unobtrusively on television set 14. In step 86, the computer video image is combined with the image generated by the video signals received from audio/video source 16, preferably by video mixer 28 to generate a combined image. In step 88, the combined image is provided to television set 14. The combined image may be presented on a display of television set 14. Because the call information occupies a small portion of the blue screen, therefore the call information may be displayed unobtrusively on television set 14. Thus, the user is able to view the call information without interrupting whatever he or she was viewing prior to receiving the incoming call.

Once the call information is displayed to the user, the user may decide to pick up the call or simply ignore the call. The user may pick up the call by selecting a “connect” option on control device 18. If the user decides to pick up the call, then a “connect” signal is sent from control device 18 to wireless adapter 38 of integration device 12. In step 90, a determination is made as to whether the “connect” signal has been received from control device 18 by wireless adapter 38. If the “connect” signal has been received, then in step 92, an audio channel is established between control device 18 and communications network 22 via communications adapter 34 and wireless adapter 38. The user may then receive the incoming call via control device 18.

If in step 90 it is determined that no “connect” signal has been received from control device 18, then in step 94 the incoming call is handled based on the rules stored in storage medium 36. Thus, for example, if the user is at home, the caller may be allowed to leave a voicemail message which may be stored in storage medium 36. If the user is not at home, then the call may be forwarded to another telephone number or the caller may be allowed to leave a voicemail message which may be stored in storage medium 36 or in voicemail system 27 associated with local telephone company central office 26.

A messaging indicator may be displayed when a voicemail message is awaiting disposition by the user either in integration device 12 or in voicemail system 27. In order to determine the presence of a voicemail message in integration device 12, storage medium 36 may be checked. In order to determine the presence of a voicemail message in voicemail system 27, communications adapter 34 listens for a “stutter” signal from communications network 22. The presence of a “stutter” signal indicates that there is a voicemail message awaiting disposition at voicemail system 27. If there is a voicemail message awaiting disposition by the user, then in response to receiving a request from the user, the voicemail message may be retrieved either from storage medium 36 or from voicemail system 27. The caller ID of the caller may be determined and content, if any, stored in the address book and associated with the caller ID may be retrieved. A blue screen with voicemail information, such as time stamp, caller ID, content, and/or the like may be generated. The blue screen may be combined with the image generated by the video signals received from audio/video source 16. The combined image may be displayed on television set 14. If the user decides to listen to the voicemail message, then an audio channel may be established and the voicemail message played back to the user over the audio channel. If the voicemail message is at voicemail system 27, then the audio channel may be established between control device 18 and communications network 22 via communications adapter 34. If the voicemail message is stored in storage medium 36, then the audio channel may be established between control device 18 and controller 30.

The user may dispose the voicemail message as desired. For example, the user may respond to the voicemail message, erase the voicemail message, forward the voicemail message, and/or the like. If desired, the user may define rules to control the flow of incoming calls or voicemail messages from the caller who had left the voicemail message. Thus, for example, the user may set-up a rule to block future calls from the caller or forward the call to a different number.

FIG. 5 is a flowchart of a preferred embodiment method of operation 100 of integration device 12 in response to receiving a signal from control device 18. Integration device 12 waits for an “Initiate Activity” signal or a “View Events” signal from control device 18 (step 102). The signal from control device 18 is preferably received by wireless adapter 38. Upon receiving a signal from control device 18, in step 104, a determination is made as to whether the received signal is a “View Events” signal. If the received signal is a “View Events” signal, then in step 106, a plurality of events such as a call log, a voicemail log, and/or the like are displayed on television set 14. The process starting at step 102 may then be executed. If in step 104 it is determined that the received signal is not a “View Events” signal, then in step 107 a determination is made as to whether the received signal is an “Initiate Activity” signal. If the received signal is not an “Initiate Activity” signal, then the process starting at step 102 may be executed. If the received signal is an “Initiate Activity Signal,” then in step 108, the user is presented with a plurality of options, for example, Display Features available, Initiate Call, and/or the like. If the user selects the Display Features option (step 110), then in step 112 the current configuration for telephony services associated with integration device 12, for example call blocking, call forwarding, rules, and/or the like are displayed. If the user decides to modify the features (step 114), then in step 116 the features are updated and saved on storage medium 36. If desired, in step 118, the updated features may be uploaded to web services server 24. The process starting at step 102 may then be executed. If in step 114 it is determined that the user does not desire to modify the features, then the process starting at step 102 may be executed.

If it is determined that the user desires to initiate a call (step 120), then in step 122, the number to be called is received. The user may initiate a call in one or more of the following ways—selecting a number from the address book, entering a number on control device 18, selecting a number from the call log, selecting a number from the voicemail log, and/or the like. In step 124, the call is initiated. An audio channel may be established between control device 18 and communications network 22 via controller 30. Voice signals from control device 18 may be transmitted to wireless adapter 38. Wireless adapter 38 may pass the signals to sound card 40 for processing. Sound card 40 processes the signals and may provide an audio path from wireless adapter 38 to communications adapter 34. The processed signals may be transmitted to communications network 22 via communications adapter 34. Two way communication between control device 18 and communications network 22 may then be performed.

A technical advantage of an exemplary embodiment of the present invention is that content, for example an image, associated with a caller ID or a caller and stored in a storage medium may be displayed, preferably unobtrusively, on the television set in response to receiving a call or a voicemail message from the caller. Thus, the user may easily determine if he wants to accept the call or listen to the voicemail message. Another technical advantage of an exemplary embodiment of the present invention is that the user may configure telephony features via a web site and store them on a web services server. The stored features may be downloaded by the integration device. Another technical advantage of an exemplary embodiment of the present invention is that the user may define one or more rules which act in conjunction with the user's calendar and/or the user's address book to automatically redirect calls to a different number, to an answering machine, and/or to a voicemail system.

While the invention has been particularly shown and described by the foregoing detailed description, it will be understood by those skilled in the art that various other changes in form and detail may be made without departing from the spirit and scope of the invention.

What is claimed is:

1. A method for presenting an incoming telephony call on a display of a television set, comprising:
receiving said incoming telephony call;
selecting at least one of a plurality of images based at least in part on a caller identification number associated with said incoming telephony call;
generating a computer video image to be presented on said display, said computer video image comprising said selected at least one image; and
providing said computer video image to said television set.

2. The method of claim 1, further comprising storing said plurality of images in a storage medium.

3. The method of claim 1, further comprising downloading said plurality of images from a web services server for storage in a storage medium.

4. The method of claim 1, further comprising combining said computer video image with an image generated from video signals received from a video source prior to providing said computer video image to said television set.

5. The method of claim 1, further comprising combining said computer video image with an image generated from video signals received from a video source to generate a combined image such that when presented on said display said combined image is unobtrusively presented on said display.

6. The method of claim 5, further comprising displaying said combined image on said display.

7. The method of claim 1, further comprising receiving a connect signal from a control device.

8. The method of claim 1, further comprising establishing an audio channel between a control device and a communications network to connect said incoming telephony call.

9. The method of claim 1, further comprising establishing an audio channel between a control device and a telephony network in response to receiving a connect signal from said control device.

10. The method of claim 1, further comprising redirecting said incoming telephony call based at least in part on a rule of a plurality of rules stored in a storage medium.

11. The method of claim 1, further comprising redirecting said incoming telephony call based at least in part on calendar information of a user stored in a storage medium.

12. The method of claim 11, further comprising redirecting said incoming telephony call based at least in part on address book information of said user stored in said storage medium.

13. The method of claim 1, further comprising redirecting said incoming telephony call based at least in part on address book information of a user stored in a storage medium.

14. The method of claim 10, further comprising downloading said plurality of rules from a web services server via a communications network.

15. The method of claim 1, wherein said generating step comprises generating said computer video image to be presented on said display, said computer video image comprising said selected at least one image and information on said incoming telephony call.

16. The method of claim 1, wherein said providing step comprises providing said computer video image to said television set for presentation on said display of said television set.

17. The method of claim 15, wherein said information on said incoming telephony call comprises information selected from the group consisting of a time stamp and said caller identification information.

18. The method of claim 1, wherein said at least one image is selected from the group consisting of a picture of a person, a logo of a company, and a video file.

19. A system for presenting an incoming telephony call on a display of a television set, comprising:
a controller operable to generate a computer video image to be presented on said display, said computer video image comprising at least one of a plurality of images selected based at least in part on a caller identification information associated with said incoming telephony call; and
a video mixer operable to receive said computer video image from said controller, said video mixer further operable to generate a combined image from said computer video image and an image generated from video signals received from a video source, and provide said combined image to said television set.

20. The system of claim 19, wherein said controller further comprises a storage medium operable to store said plurality of images.

21. The system of claim 19, wherein said controller further comprises a communications adapter operable to download said plurality of images from a web services server via a communications network for storage in said storage medium.

22. The system of claim 19, further comprising a wireless adapter operable to receive a connect signal from a control device.

23. The system of claim 20, wherein said storage medium is further operable to store a plurality of rules, wherein at least one of said plurality of rules is used to determine a number to redirect said incoming telephony call.

24. The system of claim 23, further comprising a communications adapter operable to download said plurality of rules from a web services server via a communications network.

25. The system of claim 20, wherein said storage medium is further operable to store a plurality of rules, wherein at least one of said plurality of rules operates in conjunction with calendar information of a user to redirect said incoming telephony call to one of an answering machine, a network based voicemail system, and a telephone number.

26. The system of claim 20, wherein said storage medium is further operable to store a plurality of rules, wherein at least one of said plurality of rules operates in conjunction with calendar information of a user to block said incoming telephony call.

27. The system of claim 20, wherein said storage medium is further operable to store a plurality of rules, wherein at least one of said plurality of rules operates in conjunction with calendar information of a user to screen said incoming telephony call.

28. The system of claim 19, wherein said at least one image is selected from the group consisting of a picture of a person, a logo of a company, and a video file.

29. A method for presenting an incoming telephony call on a display of a television set, comprising:
receiving said incoming telephony call;
determining a caller identification number associated with said incoming telephony call;
selecting at least one image from a plurality of images based at least in part on said caller identification number in response to said caller identification number not being blocked;
generating a computer video image to be presented on said display, said computer video image comprising said selected at least one image; and
providing said computer video image to said television set.

30. The method of claim 29, further comprising enabling a user to configure a plurality of telephony features and a plurality of rules via a web site.

31. The method of claim 30, further comprising storing said plurality of telephony features and said plurality of rules in said web services server.

32. The method of claim 30, further comprising downloading said plurality of telephony features and said plurality of rules from said web services server via a communications network.

33. A method for presenting an incoming telephony call on a display of a television set, comprising:
receiving said incoming telephony call;
selecting electronic content based at least in part on a caller identification number associated with said incoming telephony call;
generating a computer video image to be presented on said display, said computer video image comprising said selected electronic content; and
providing said computer video image for presentation on said display of said television set.

34. The method of claim 33, further comprising storing said electronic content in a storage medium.

35. The method of claim 33, wherein said selected electronic content comprises electronic content selected from the group consisting of an image file and a video file.
